(19) United States
(12) Patent Application Publication
(10) Pub. No.: US 2006/0066000 A1
(43) Pub. Date: Mar. 30, 2006

(54) Tow-based wipes

(75) Inventor: John Litvay, Downingtown, PA (US)

Correspondence Address: Tyco Healthcare Retail Group;Attn: Debby Kirchhevel, 601 Allendale Road, King of Prussia, PA, 19406, US

(73) Assignee: Tyco Healthcare Retail Services, AG

(21) Appl. No.: 10/950,336

(22) Filed: Sep. 27, 2004

(51) Int. Cl. B29C 47/00

(52) U.S. Cl. 264/148; 264/284; 264/282; 264/444; 425/371

(57) ABSTRACT

The present invention is directed to a method and a product produced by the method, of manufacturing a tow-based wipe, such as one made of a polyolefin material, comprising at least one tow blooming device for blooming tow material, at least one sheet forming method for forming the bloomed tow into a sheet and for projecting the sheet on to a processing path, and at least one cutting device to cut or perforate the sheet into individual wipes of a pre-determined length while on the processing path.

### SUMMARY OF INVENTION

The present invention is directed to a method and a product produced by the method, of manufacturing a tow-based wipe, such as one made of polyolefin material, comprising at least one tow blooming means for blooming tow material, at least one sheet forming means for forming the bloomed tow into a sheet and for projecting the sheet onto a processing path, and at least one cutting means to cut the sheet into individual wipes of a pre-determined dimension while on the processing path.

The present invention is further directed to a method and a product produced by said method, wherein the tow-based wipe manufacturing process further includes embossing, crimping and point bonding of the wipe.

The present invention is further directed to an apparatus for fabricating tow-based wipes comprising a tow supply component wherein draw rolls move tow into a tow blooming means and wherein the tow exits the tow blooming means bloomed, a sheet forming component wherein vacuum draw rolls move tow from the tow blooming means, and wherein the bloomed tow exits the forming jet assembly in the form of a sheet and is projected onto a processing path, and a sheet cutting component wherein the sheet is cut into individual wipes of a predetermined dimension while on the processing path.

### BRIEF DESCRIPTION OF DRAWINGS

FIG. 1 is an illustration of an apparatus useful in carrying out a method of making a tow-based wipe in accordance with the present invention.

FIG. 2 is an illustration of an apparatus useful in carrying out a method of making a tow-based wipe in accordance with the present invention, and wherein the resulting sheet comprises three layers, an embossing pattern, and ultrasonic point bonds.

### DETAIL DESCRIPTION OF INVENTION

The present invention is directed to a method and a product produced by the method, of manufacturing a tow-based wipe, such as one made of a polyolefin material, comprising at least one tow blooming means for blooming tow material, at least one sheet forming means for forming the bloomed tow into a sheet and for projecting the sheet onto a processing path, and at least one cutting means to cut the sheet into individual wipes of a pre-determined dimension while on the processing path.

The present invention is further directed to a method and a product produced by said method, wherein the tow-based wipe manufacturing process further includes embossing, crimping and point bonding of the wipe.

Further still, the present invention is directed to an apparatus for fabricating tow-based wipes comprising a tow supply component wherein draw rolls move tow into a tow blooming means and wherein the tow exits the tow blooming means bloomed, a sheet forming component wherein a vacuum draw roll move tow from the tow blooming means and wherein the bloomed tow exits the tow blooming means in the form of a sheet and is projected onto a processing path, and a sheet cutting component wherein the sheet is cut into individual wipes of a predetermined dimension while on the processing path.

Throughout this description, the expression “tow” relates in general to any continuous fiber such as polyethylene or polypropylene filaments. Tows typically are used in the manufacture of staple fibers, and may be comprised of natural or synthetic thermoplastic polymers. Usually, numerous filaments are produced by melt extrusion of the molten polymer through a multi-orifice spinneret during manufacture of staple fibers from synthetic thermoplastic polymers in order that reasonably high productivity may be achieved. The groups of filaments from a plurality of spinnerets typically are combined into a tow that is then subjected to a drawing operation to impart the desired physical properties to the filaments comprising the tow. Tow as used in the context of the present invention also encompasses modified tow fibers that have been either surface or internally modified (chemically or otherwise) to improve various desired properties of the fibers (e.g., wicking, etc.). In one embodiment of the current invention, tow comprises polypropylene, but it may be comprised of other synthetic or natural polymers. Some examples of other polymers suitable for producing tow are polyethylene, polyester, and rayon.

As stated above the method of the present invention comprises at least one tow blooming means. The term “tow blooming means” refers to a mechanical component that enables the blooming of tow material from a dense matrix of fibers into a more voluminous cotton-like matrix. Various methods and devices to open (also known as “fluffing” or “blooming”) tow and form the opened fibers into a fibrous mass are known in the art and will be discussed later in this description.

The term “sheet forming means” refers to a device or devices that work alone or in combination to move the bloomed tow from the tow blooming means and projecting it onto the processing path while at the same time adjusting or maintaining the basis weight of the individual layers of tow, which comprises the sheet. The dimensions of the tow blooming means primarily determine the width of the sheet.

The method of the present invention may further comprise an embossing means. The term “embossing means” refers to a device for applying an embossment pattern to said sheet while on the processing path. For example, the sheet could be fed through a nip formed by pair of compression rollers consisting of a smooth surface anvil and a roll with a pattern of raised surfaces. Alternately, as illustrated by embossing means 202 in FIG. 2, the sheet may be fed through a nip formed by a pair of compression rollers having complementary patterns of raised surfaces. In both examples, the raised surfaces compress the sheet providing a pre-determined embossment pattern. The compression provided by the embossment process sets the tow fibers thereby providing structural stability to the sheet.

To increase the structural stability even further, the method of the present invention may comprise a point bonding means for applying a pattern of intermittent bond points to the sheet while on the processing path. The point bonding means may be an ultrasonic point bonder; such as bonder 202 illustrated in FIG. 2, or some other type of fusion bonder. A thermal bonder is another example of a fusion type bonder.

The method of the present invention may also comprise a crimping means for crimping the edges of the sheet while on the processing path. The crimping means can be a set of crimping rollers or any other crimping device known to those having ordinary skill in the art. Crimping the edges of the sheet is another means of adding structural stability to the sheet.

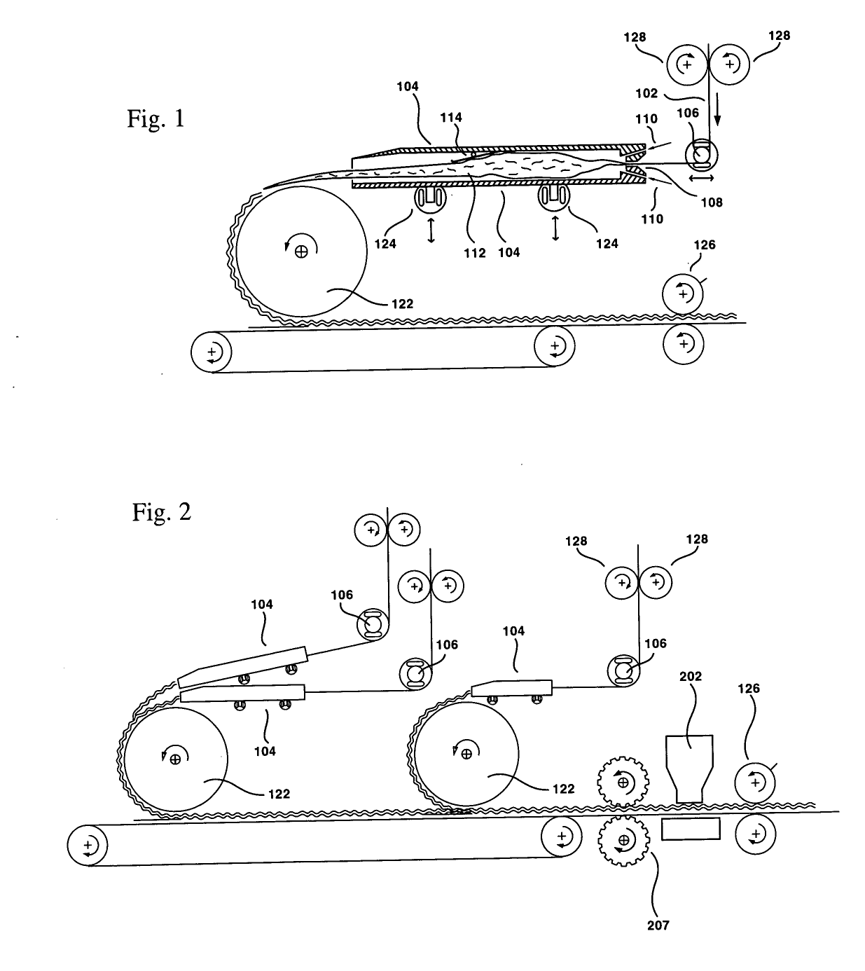

The method of the present invention further comprises at least one cutting means. The term “cutting means” or “cutting component” refers to any suitable cutting device capable of cutting the sheet into individual wipes of a pre-determined dimension while on the processing path. For example, illustrated in FIG. 1, cutting means 126 is comprised of a set of rollers; one is an anvil, and the other one has a knife attached at one point on the roller, whereby the diameter of the roller is selected to yield the desired cut length. The knife roller and anvil roller rotate at the same speed as the line speed to cut the sheet supply to uniform pre-determined lengths. Skilled artisans are capable of designing a suitable cutting knife given the specifics of the assembly line and the pre-determined cut length.

As shown in FIG. 1 and according to an exemplary embodiment of the present invention, tow supply 102 which may be unopened or partially opened, is provided along a path to enter a forming jet assembly (tow blooming means) 104. The tension, speed and path of the tow supply may be adjusted by one or more movable pulleys, guides (not shown) and/or festoons (not shown), as are known in the art. The tow supply 102 enters the forming jet assembly 104 and is opened. The forming jet assembly 104 comprises a tow inlet 108 at one end into which the tow supply 102 is fed. One or more high velocity jets 110 of air or other gas are projected into the forming jet assembly 104 to impinge upon the tow supply 102 to thereby separate the fibers and “bloom” or open the tow. Two jets 110 are used and each jet 110 is located proximal to the tow inlet 108 and on opposite sides of the tow supply 102. Also exemplary, each of the jets 110 comprises a flow of air moving at about 17.5 cubic feet per minute through a slit-shaped port that has a length of about 3.94 inches and a width of about 0.003 inches. Similar devices for opening tow are known in the art, and disclosed, for example, in U.S. Pat. No. 5,331,976 to St. Pierre, which is incorporated by reference in its entirety and in a manner consistent with the present invention. Other devices and procedures for opening the tow supply 102 may also be used with the present invention.

The opened or “bloomed” tow 112 accumulates within the forming jet assembly 104 as it is being used, and the amount of opened tow 112 being consumed may be measured by a level meter 114. The level meter 114 (also known as a “dancer”) may be any suitable electromechanical, optical, or other type of device capable of measuring the amount of opened tow being consumed. In said embodiment, the level meter 114 is a plate that is pivotally attached to a rotary position sensor (such as a commonly known variable resistance or potential device). As the level of opened tow 112 increases or decreases, the plate pivots up and down, thereby changing the output of the rotary position sensor. The level meter 114 is used as part of a closed-loop feedback algorithm or an open-loop algorithm to meter the rate at which tow supply 102 is fed into the forming jet assembly 104.

The opened tow 112 is pulled out of the forming jet assembly 104 by a vacuum draw roll 122 or a similar drawing device. Vacuum draw roll 122 has a generally cylindrical surface with a vacuum surface forming a circumferential belt on the cylindrical surface. The vacuum surface comprises one or more holes through which a vacuum is applied to the sheet supply. The holes in the vacuum surface may be formed by any means known in the art, such as drilling, machining, casting and so on. The holes may be spaced in a rectilinear array, as staggered rows, or in any other pattern that conveys the desired amount of vacuum. The vacuum surface also may comprise any other relatively rigid structure; such as one or more mesh screens or removable perforated plates that are affixed to openings in the cylindrical surface. A vacuum is applied to the vacuum draw roll through a vacuum port.

The opened tow 112 exit the forming jet assembly 104 at an angle that may be adjusted by altering the position of the vacuum draw roll 122 (or similar device), or by adjusting the height and angle of the forming jet assembly 104 using adjustable mounts 124. Increasing or decreasing the tow exit angle increases or decreases the drag on the opened tow 112 and thereby increases or decreases the amount of stretch that the vacuum draw roll 122 imparts on the opened tow 112. Greater stretch reduces the basis weight of the opened tow 112 that is pulled onto the vacuum draw roll 122. The tow forming jet 104 is aligned so that its outlet is tangential to the vacuum draw roll 122 or slightly above a tangent to the vacuum draw roll 122. In another embodiment, the amount of stretch on the opened tow 112 may instead (or additionally) be regulated by operating the dancer 114 as a baffle (instead of using it as a level meter) to pinch down on the opened tow 112 as it is pulled onto the vacuum draw roll 122, and thereby increase the stretch of the opened tow 112. By using the dancer as a baffle, it is expected that adjustments of up to +/−10% may be made to the tow stretch or basis weight of each layer of the sheet.

Products made by the present invention include ones made from polyolefin material, such as polypropylene tow, with a denier per fiber (dpf) measurement within the range of about 5 to 30 (dpf). For the same weight product, filaments of lower dpf may provide increased surface area and increased moisture absorption. Total denier may vary within the range of about 5,000 to 60,000, depending upon a desired predetermined weight. In addition, such wipes can be made of one or more layers of such materials or various combinations of such materials.

The specification should be considered exemplary only, and the scope of the invention is accordingly intended to be limited only by the following claims and equivalents thereof.

1) A method of manufacturing a tow-based wipe comprising:
a) at least one tow blooming means for blooming tow material;
b) at least one sheet forming means for forming the bloomed tow into a sheet and for projecting the sheet onto a processing path; and
c) at least one cutting means to cut the sheet into individual wipes of a pre-determined dimension while on the processing path;
wherein the tow is continuously fed from the tow supply into the tow blooming means during the manufacturing of the tow-based wipes.

2) The product produced by the process of claim 1.

3) The method of claim 1, further comprising an embossing means for applying an embossing pattern on said sheet while on the processing path.

4) The method of claim 1, further comprising a crimping means for crimping the edges of the sheet while on the processing path.

5) The method of claim 1, further comprising a point bonding means for applying point bonding to the sheet while on the processing path.

6) The method of claim 5, wherein the point bonding means is an ultrasonic point bonder.

7) The method of claim 1, wherein tow comprises one or more polyolefin material.

8) The method of claim 1, wherein the tow has a denier per fiber measurement within the range of about 5 to 30 dpf.

9) The method of claim 1, wherein the tow has a total denier measurement in the range of about 5,000 to 60,000 dpf.

10) The method of claim 1, wherein the tow supply means comprises at least one jet.

11) The method of claim 1, wherein the sheet forming means uses a vacuum draw roll to form the sheet.

12) The method of claim 1, wherein the sheet has a total basis weight in the range of about 30 grams per square meter to about 100 grams per meter.

13) The method of claim 1, wherein the sheet comprises more than one layer.

14) The method of claim 1, wherein the sheet comprises three layers including:
a) a first layer comprising tow having a denier per fiber is in the range of about 5 to about 15 dpf;
b) the second layer comprising tow having a denier per fiber in the range from about 10 to about 30 dpf; and
c) a third layer comprising tow having a denier per fiber that is about equal to the denier per fiber of the first layer, wherein the second layer is disposed between the first and third layers.

15) The method of claim 1, wherein the sheet comprises two layers including:
a) a first layer comprising tow having a denier fiber in the range from about 5 to about 15 dpf; and
b) a second layer comprising tow having a denier per fiber in the range from about 10 to about 30 dpf.

16) A method of manufacturing wipes comprising:
a) at least one tow supply means for blooming polyolefin tow;
b) at least one sheet forming means for forming the tow into said a sheet prior to being applied to a processing path;
c) at least one embossing means for embossing the sheet;
d) at least one point bonding means for point bonding the sheet;
e) at least one crimping means for crimping the edges of the sheet; and
f) at least one cutting means for cutting the sheet into wipes of a predetermined dimension.

17) The product produced by the process of claim 16.

18) The method of claim 16, wherein the polyolefin tow comprises polypropylene.

19) An apparatus for fabricating tow-based wipes comprising:
a) a tow supply component wherein draw rolls moves tow into a tow blooming means and wherein the tow exits the tow blooming means bloomed;
b) a sheet forming component wherein a vacuum draw roll moves tow from a tow blooming means and wherein the bloomed tow exits the tow blooming means in the form of a sheet and is projected on to a processing path;
c) a sheet cutting component wherein the sheet is cut into individual wipes of a predetermined dimension while on the processing path;
wherein the tow is continuously fed from the tow supply into the tow blooming means during the manufacturing of the tow-based wipes.
